(19) United States
(12) Patent Application Publication
(10) Pub. No.: US 2007/0102583 A1
(43) Pub. Date: May 10, 2007

(54) Systems and methods for reducing surge loads in hose assemblies, including aircraft refueling hose assemblies

(76) Inventors: Theron L. Cutler, Wichita, KS (US); Mark A. Shelly, Bel Aire, KS (US)

Correspondence Address: PERKINS COIE, LLP, P.O. BOX 1247, PATENT - SEA, SEATT;E, WA, 98111-1247, US

(21) Appl. No.: 11/258,819

(22) Filed: Oct. 26, 2005

(51) Int. Cl. B64D 39/00

(52) U.S. Cl. 244/135 A

(57) ABSTRACT

Systems and methods for reducing surge loads in hose assemblies, including aircraft refueling hose assemblies, are disclosed herein. A system in accordance with one embodiment includes a fuel delivery device having a flexible fuel line configured to be deployed overboard an aircraft during aerial refueling and a drogue coupled to the fuel line. The system can further include a surge damping portion positioned along the fuel line away from the aircraft to suppress surge loads traveling along the fuel line. In several embodiments, the surge damping portion can include a compressible material disposed annularly about at least a portion of the fuel line.

### TECHNICAL FIELD

The present invention is directed generally toward reducing surge loads in hose assemblies, including reducing surge loads in hose assemblies used in systems for in-flight refueling of aircraft.

### BACKGROUND

In-flight refueling (or air-to-air refueling) is an important method for extending the range of aircraft traveling long distances over areas having no feasible landing or refueling points. Although in-flight refueling is a relatively common operation, especially for military aircraft, the aircraft to be refueled (e.g., the receiver aircraft) must be precisely positioned relative to the tanker aircraft in order to provide safe engagement while the fuel is dispensed to the receiver aircraft. The requirement for precise relative spatial positioning of the two rapidly moving aircraft makes in-flight refueling a challenging operation.

There are currently two primary systems for in-flight refueling. One is a hose and drogue system, which includes a refueling hose having a drogue disposed at one end. The hose and drogue are trailed behind the tanker aircraft once the tanker aircraft is on station. The pilot of the receiver aircraft then flies the receiver aircraft to intercept and couple with the drogue for refueling. Another existing system is a boom refueling system. The boom refueling system typically includes a rigid boom extending from the tanker aircraft with a probe and nozzle at the distal end. The boom also includes airfoils controlled by a boom operator stationed on the refueling aircraft. The airfoils allow the boom operator to actively maneuver the boom with respect to the receiver aircraft, which flies in a fixed refueling position below and aft of the tanker aircraft.

One challenge associated with in-flight refueling systems includes surge loads generated during the refueling process. For example, high surge pressures can be generated in the refueling hose by any sudden or rapid changes in the flow rate of fuel passing through the refueling hose (e.g., starting or stopping the fuel flow, increasing or decreasing the fuel flow, etc.) The sudden changes in flow rate can in turn cause surge loads or surge pulses in the system, which can travel up the refueling hose and back into the tanker aircraft fuel system. In some instances, the surge loads can damage the various components of the fuel system (e.g., pumps, tanks, plumbing, etc.) and/or other aircraft systems or components. One approach for damping or otherwise suppressing such surge loads is to use surge suppressors positioned within the aircraft at various locations along the fuel system to intercept the surge loads. Conventional surge suppressors can include, for example, one or more canisters having bladders or other types of suppression areas positioned to absorb at least a portion of the surge loads before the loads can potentially damage the various systems of the aircraft.

One drawback with conventional surge suppressors, however, is that they are typically not designed for the large surge loads generated during in-flight refueling operations. Most surge suppressors are only configured to handle the relatively small surge loads generated during ground refueling operations, rather than the large surge loads that can be generated during in-flight refueling operations. Another drawback with conventional surge suppressors is that the bladders need to be filled or “charged” with nitrogen or another suitable gas both before and during use. The charging process can be time-consuming and inefficient, and can create a requirement for additional hardware on the aircraft (e.g., pumps, tanks, plumbing, etc.) Still another drawback with conventional surge suppressors is that the performance of the suppressors can change significantly based on the operating conditions of the aircraft. For example, the gas in the bladder can be affected by changes in temperature and/or pressure as the aircraft is in flight. Such changes can negatively affect the performance of the surge suppressor, particularly during in-flight refueling operations when the generated surge loads can be relatively large. Accordingly, there is a need to improve the systems and methods for suppressing or otherwise reducing surge loads in hose assemblies.

### SUMMARY

The following summary is provided for the benefit of the reader only, and does not limit the invention. Aspects of the invention are directed generally to aerial refueling systems. An airborne refueling system in accordance with one aspect of the invention includes a fuel delivery device having a flexible fuel line configured to be deployed overboard an aircraft during aerial refueling and a drogue coupled to the fuel line. The system can further include a surge damping portion positioned along the fuel line away from the aircraft to suppress surge loads traveling along the fuel line.

In several embodiments, the surge damping portion can include a compressible material disposed annularly about at least a portion of the fuel line. The compressible material can include, for example, solid rubber, foam rubber, silicone rubber, a foam material such as closed-cell foam or other suitable types of foam, or other suitable materials having a desired damping characteristic. In other embodiments, the surge damping portion and corresponding compressible material can include a bladder disposed annularly about at least a portion of the fuel line at least partially filled with a gas (e.g., air or another suitable gas). In still further embodiments, the system can include a plurality of surge damping portions positioned along the fuel line away from the aircraft.

A system for reducing surge loads in hose assemblies in accordance with another aspect of the invention can include a hose having a first segment and a second segment. The hose can include any type of flexible fluid conduit configured to carry a fluid. The system can further include a surge damping portion positioned annularly about at least a portion of the second segment of the hose. The surge damping portion is positioned to dampen radially expanding surge loads traveling along a longitudinal axis of the hose. In several embodiments, the surge damping portion can include a compressible material disposed annularly about at least a portion of the second segment of the hose.

A method for refueling an aircraft in accordance with another aspect of the invention can include aerially deploying from a tanker aircraft a portion of a refueling system that includes a flexible fuel line and a drogue. The method can further include suppressing surge loads traveling along the fuel line using a surge damping portion positioned along at least a portion of the fuel line away from the tanker aircraft. In several embodiments, for example, suppressing surge loads traveling along the fuel line includes transferring energy from radially expanding surge loads into a compressible material disposed annularly about at least a portion of the fuel line.

### BRIEF DESCRIPTION OF THE DRAWINGS

FIG. 1 is a partially schematic, isometric illustration of a tanker aircraft having an aerial refueling device including a surge damping portion configured in accordance with several embodiments of the invention.

FIG. 2A is an enlarged, partially schematic side cross-sectional view of a portion of a hose assembly of the aerial refueling device and the surge damping portion shown in FIG. 1.

FIG. 2B is a cross-sectional view of the hose assembly and the surge damping portion taken along line 2B-2B of FIG. 2A.

FIGS. 3A-3C are enlarged, partially schematic side cross-sectional views of the surge damping portion illustrating stages of a method for damping or otherwise suppressing a surge load using the surge damping portion of FIGS. 1-2B.

FIG. 4 is an enlarged, partially schematic side cross-sectional view of a portion of a hose assembly and a surge damping portion configured in accordance with another embodiment of the invention.

FIG. 5 is an enlarged, partially schematic side cross-sectional view of a portion of a hose assembly and a surge damping portion configured in accordance with still another embodiment of the invention.

FIG. 6 is an enlarged, partially schematic side cross-sectional view of a portion of a hose assembly and a surge damping portion configured in accordance with yet another embodiment of the invention.

### DETAILED DESCRIPTION

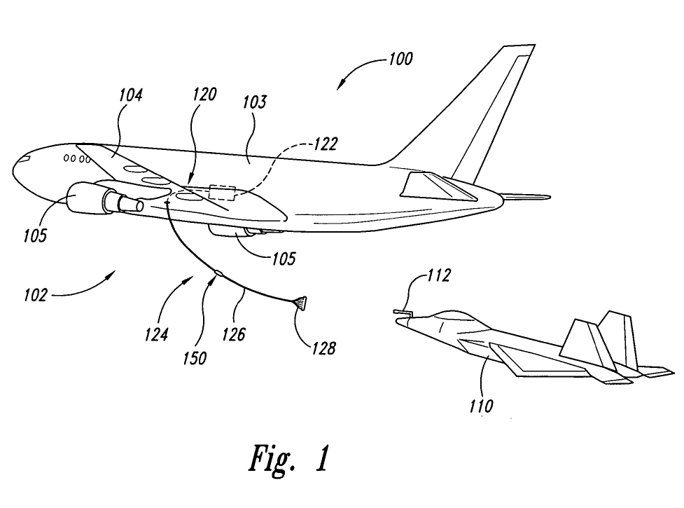

The present disclosure describes systems and methods for reducing surge loads in hose assemblies, including surge loads in hose assemblies used in aircraft refueling systems. Certain specific details are set forth in the following description and in FIGS. 1-6 to provide a thorough understanding of various embodiments of the invention. Well-known structures, systems and methods often associated with such systems have not been shown or described in detail to avoid unnecessarily obscuring the description of the various embodiments of the invention. In addition, those of ordinary skill in the relevant art will understand that additional embodiments of the invention may be practiced without several of the details described below.

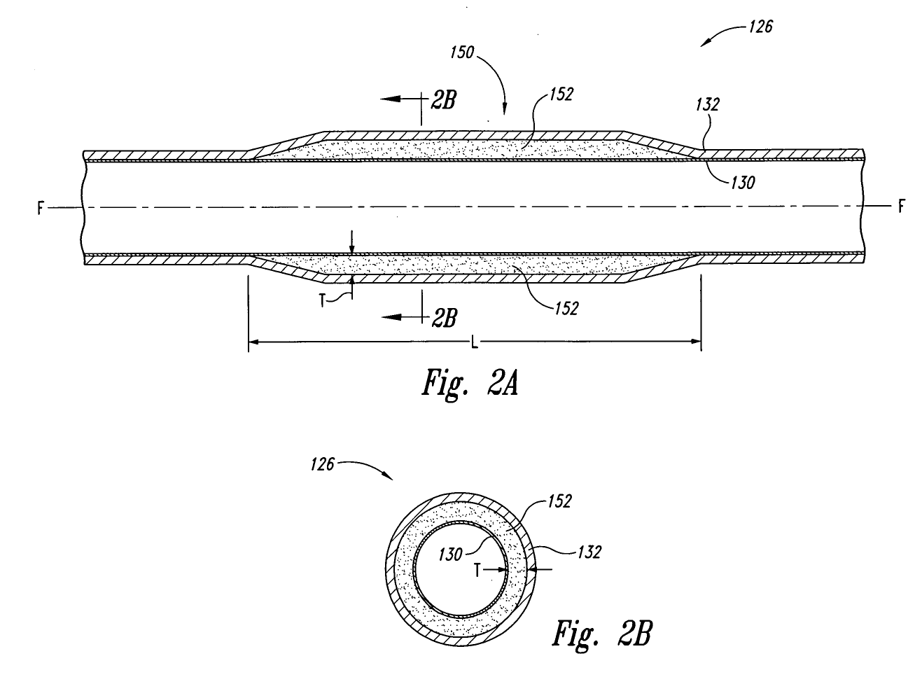

FIG. 1 illustrates a system 100 that includes a tanker aircraft 102 positioned to couple with and refuel a receiver aircraft 110 using an aerial refueling device 120 configured in accordance with an embodiment of the invention. The tanker aircraft 102 has a fuselage 103, wings 104, and one or more engines 105 (two are shown in FIG. 1 as being carried by the wings 104). In other embodiments, the aircraft 102 can have other configurations. In a particular aspect of the embodiment shown in FIG. 1, the aerial refueling device 120 can include an on-board portion 122 (e.g., a hose reel activator and associated valving) and a deployable portion 124. The deployable portion 124 can include a flexible fuel line or hose 126 and a drogue 128. The position of the drogue 128 can be controlled to couple with a probe 112 of the receiver aircraft 110. The hose 126 can include one or more surge damping portions 150 (only one is shown in FIG. 1) configured to damp or otherwise suppress surge loads traveling through the hose 126 from the drogue 128 toward the on-board portion 122 of the refueling device 120. Further details of the surge damping portion 150 and associated systems and methods for damping and/or suppressing surge loads are described below with reference to FIGS. 2A-6.

FIG. 2A is an enlarged, partially schematic side cross-sectional view of a portion of the hose 126 and the surge damping portion 150 shown in FIG. 1. The hose 126 includes a fluid conduit having an inner portion or layer 130 surrounded by an outer portion or layer 132. The inner and outer layers 130 and 132 of the hose 126 extend along a longitudinal or flow axis F of the hose 126. The inner layer 130 of the hose 126 can be configured to carry fuel or other types of liquids. In several embodiments, for example, the inner layer 130 can include a soft rubber material that acts as a fluid seal. As described in greater detail below, the inner layer 130 can also be configured to transmit surge loads into the surge damping portion 150.

The outer layer 132 of the hose 126 is an outer body that can provide a protective shroud or layer around the inner layer 130 in case of a liquid and/or vapor leak in the inner layer 130. Accordingly, the outer layer 132 is generally isolated from fluid communication with the fuel or other liquid in the hose 126. The outer layer 132 can include a rubber material or other suitable material that meets the desired operational requirements for the hose 126 (e.g., flexibility, strength, rigidity, etc.) In other embodiments, the inner layer 130 and/or the outer layer 132 of the hose 126 can be formed from other suitable materials or have other arrangements.

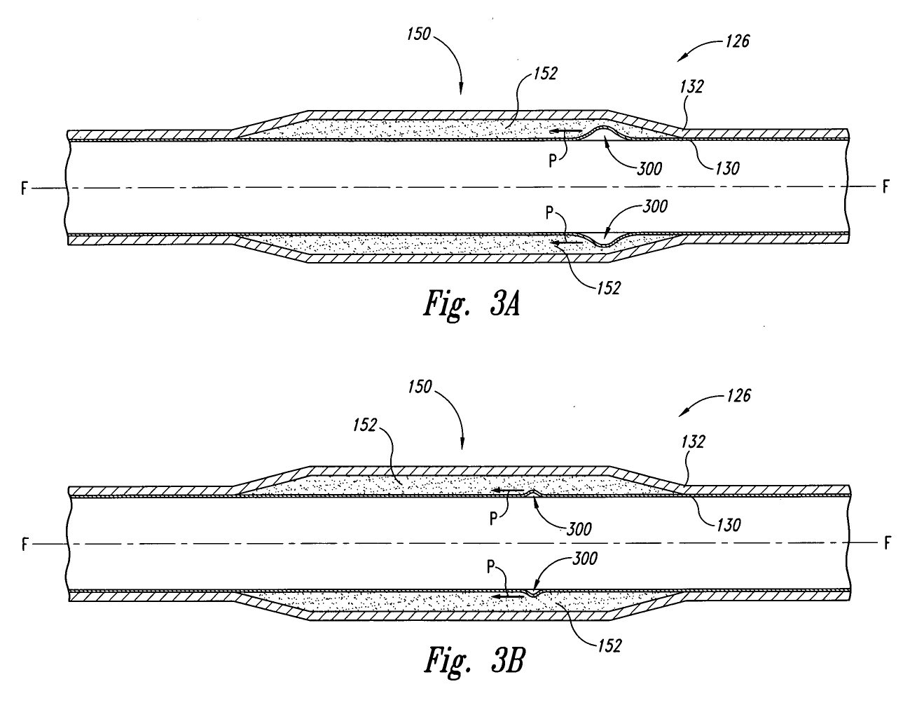

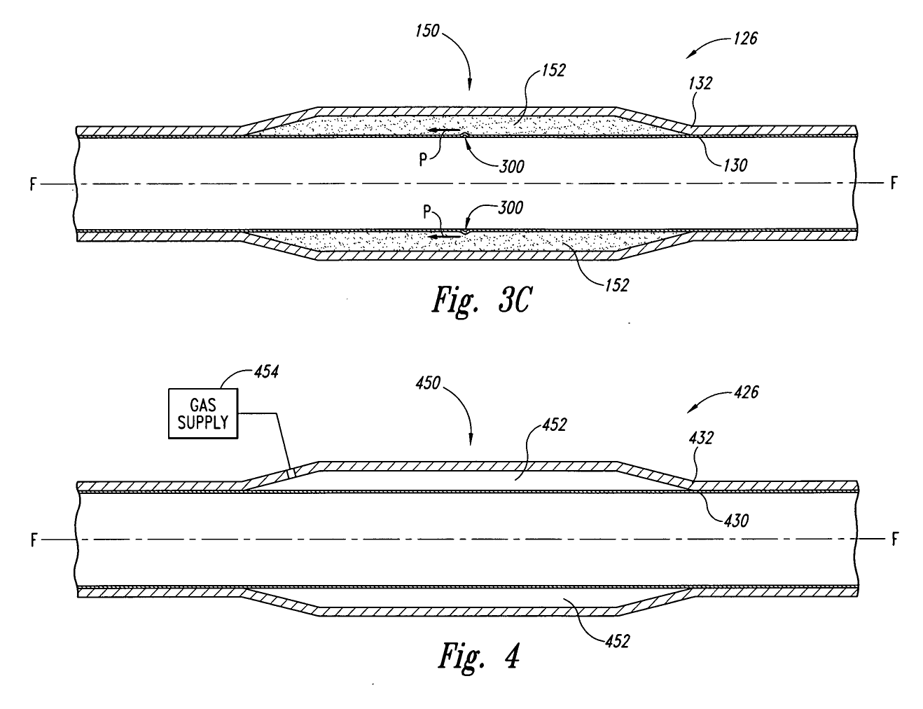

FIG. 2B is a cross-sectional view of the hose 126 and the surge damping portion 150 taken along line 2B-2B of FIG. 2A. Referring to FIGS. 2A and 2B together, the surge damping portion 150 can include a compressible material 152 disposed annularly about the hose 126 such that the compressible material 152 is an integral part of the hose 126 between the inner layer 130 and the outer layer 132 of the hose 126. As described in greater detail below with respect to FIGS. 3A-3C, the compressible material 152 is positioned to absorb energy from a surge load traveling through the hose 126. The compressible material 152 can include solid rubber, foam rubber, silicone rubber, a foam material such as closed-cell foam or other suitable types of foam, or a variety of other suitable materials having the desired damping characteristics. Furthermore, in other embodiments described below with FIG. 4 the compressible material can include a suitable gas.

The compressible material 152 of the surge damping portion 150 can have a durometer value of approximately 10 to 90. The durometer value of the compressible material 152 can vary in accordance with the desired damping characteristics and/or operational requirements for the hose 126 and corresponding surge damping portion 150. Although compressible material 152 having a lower durometer value can improve the damping rate of the surge damping portion 150, the durometer value of the compressible material 152 should not be so low that the material overheats during operation. Furthermore, the durometer value of the compressible material 152 should be sufficient to provide the necessary stiffness to the hose 126 to meet the necessary operational requirements (e.g., flight loads during refueling operations). On the other hand, the durometer value should not be so high that the hose 126 and corresponding surge damping portion 150 are too stiff and/or do not have a desired damping functionality.

In the illustrated embodiment, the surge damping portion 150 has a length L (as shown in FIG. 2A) along the hose 126 and a thickness T (shown in both FIGS. 2A and 2B) between the inner layer 130 and the outer layer 132 of the hose 126. The length L and thickness T of the surge damping portion 150 can be adjusted based on the desired damping characteristics for a particular application. In applications where large surge loads are expected, for example, the length L and/or thickness T can be increased to accommodate the larger loads. On the other hand, in applications where the surge loads are anticipated to be relatively small, the length L and/or thickness T of the surge damping portion 150 can be decreased.

FIGS. 3A-3C are enlarged, partially schematic side cross-sectional views of the surge damping portion 150 shown in FIGS. 1-2B illustrating stages of a method for damping or otherwise suppressing a surge load in accordance with an embodiment of the invention. FIG. 3A, for example, illustrates a preliminary stage of the method in which a surge pulse or surge load 300 initially reaches the surge damping portion 150 of the hose 126. Surge pulses generated by fuel or other fluids passing through the hose 126, such as the surge pulse 300 in the illustrated embodiment, generally include a radially expanding wave traveling along the hose from the drogue 128 (FIG. 1) toward the on-board portion of the refueling device 120 (FIG. 1). In the illustrated embodiment, for example, the surge pulse 300 is a wave traveling in a direction generally parallel to the flow axis F of the hose 126 (as shown by the arrows P). In one particular aspect of this embodiment, the inner layer 130 of the hose 126 includes a relatively soft rubber material configured to transmit the surge pulse 300 into the compressible material 152. Accordingly, when the surge pulse 300 reaches the surge damping portion 150 of the hose 126, the surge pulse 300 begins to expand into the compressible material 152 as shown in FIG. 3A.

Referring next to FIG. 3B, the surge pulse 300 continues to travel in the direction P along the hose 126. As the surge pulse 300 passes through the compressible material 152 of the surge damping portion 150, however, the energy from the surge pulse 300 is transferred to the compressible material 152 as the surge pulse displaces portions of the compressible material. In this way, the energy from the surge pulse 300 is converted to heat and, accordingly, the surge pulse 300 itself begins to shrink or otherwise dissipate. Referring to FIG. 3C, for example, the surge pulse 300 has passed through approximately half the length of the surge damping portion 150, and the surge pulse 300 is generally dissipated. As discussed previously, the energy (i.e., heat, pressure, etc.) from the surge pulse 300 can be transferred to the compressible material 152, the hose 126, and/or the fluid (not shown) passing through the hose 126.

One feature of at least some of the embodiments of the surge damping portion 150 described above is that the surge damping portion 150 is relatively light and inexpensive compared with conventional surge suppression systems that can include a series of pumps and tanks to charge the nitrogen-filled canisters, as described previously. An advantage of this feature is that the surge damping portions 150 can significantly decrease the operating weight of the aerial refueling device 120 (FIG. 1), which can increase efficiency and reduce the cost of operating the refueling system. Another advantage of this feature is that the complexity of the aerial refueling system is significantly reduced because the surge damping portion 150 does not require any additional tanks, pumps, or controllers for operation.

Another feature of at least some of the embodiments of the surge damping portion 150 described above is that the damping characteristics of the surge damping portion 150 are customizable based on anticipated loading conditions and/or operational conditions. For example, the length L and the thickness T of the compressible material 152 can be adjusted to accommodate a number of different loading conditions. The damping characteristics can be further adjusted by selecting a certain type of material having a desired durometer value for the compressible material 152. An advantage of these features is that a hose for an aerial refueling system (such as the aerial refueling device 120 of FIG. 1) can be designed to satisfy a number of different operational conditions. Furthermore, additional hoses with different suppression characteristics can be designed for the system and can be quickly and easily exchanged with the existing hose to accommodate varying operational requirements.

Still another feature of at least some of the embodiments of the surge damping portion 150 described above is that the surge damping portion of the hose 126 is positioned relatively close to the source of the surge loads (e.g., at or proximate to the drogue 128 (FIG. 1) at a distal end of the hose 126). An advantage of this feature is that it can be significantly more effective to dampen or otherwise suppress surge loads or surge pulses close to the source of the surge load when the surge load is at or near its peak because it is generally easier to transfer large amounts of energy from large surge loads as opposed to transferring energy from smaller surge loads. For example, a large surge load will generally displace a larger volume of compressible material 152 and, accordingly, transfer more energy from the surge load to the compressible material 152. The surge damping portion 150 proximate to the distal end of the hose 126 is accordingly expected to significantly improve the ability of the system to dampen or otherwise suppress large surge loads as compared with conventional surge suppressors that are positioned within the aircraft a large distance away from the source of the surge loads.

FIG. 4 is an enlarged, partially schematic side cross-sectional view of a portion of a hose assembly 426 and a surge damping portion 450 configured in accordance with another embodiment of the invention. The hose assembly 426 and surge damping portion 450 can be used with the aerial refueling device 120 of FIG. 1, or other suitable aerial refueling systems. The hose 426 illustrated in FIG. 4 can be generally similar to the hose 126 described above with respect to FIGS. 2A and 2B. For example, the hose 426 includes an inner layer or layer 430 surrounded by an outer layer or layer 432. The inner and outer layers 430 and 432 can be formed from materials generally similar to the inner and outer layers 130 and 132 of the hose 126 described above with respect to FIGS. 2A and 2B.

The surge damping portion 450 can be positioned along a portion of the hose 426 to damp or otherwise suppress surge loads traveling along the hose 450. The surge damping portion 450 differs from the surge damping portion 150 described above with respect to FIGS. 2A-2B in that the surge damping portion 450 does not include a compressible material positioned between the inner and outer layers 430 and 432 of the hose 426. Instead, the surge damping portion 450 includes one or more bladders 452 (only one is shown in FIG. 4) positioned between the inner and outer layers 430 and 432 of the hose 426. The bladder 452 is configured to be filled with a gas (e.g., air, nitrogen, or other suitable gases) using a gas supply 454 (shown schematically) operably coupled to the bladder 452.

The bladder 452 can function in much the same way as the compressible material 152 of the surge damping portion 150 described above with respect to FIGS. 2A-3C. For example, the bladder 452 can receive and dissipate surge loads in much the same way as the compressible material 152 described above. One particular aspect of this embodiment, however, is that the pressure within the bladder 452 can be adjusted during operation to dynamically adjust the damping or suppressing characteristics of the surge damping portion 450 based on the anticipated surge loads and/or operational conditions. For example, in situations where the surge loads are anticipated to be relatively high, the pressure in the bladder 452 can be increased to withstand the large loads. In other operational situations (either during the same refueling operation or during another refueling operation) when the surge loads are anticipated to be smaller, the pressure in the bladder 452 can be decreased. An advantage of this feature is that the hose 426 including the surge damping portion 450 can be used in a variety of operational situations, rather than requiring a user to change out the entire hose 426 or provide other types of additional surge suppression mechanisms to account for varying surge loads.

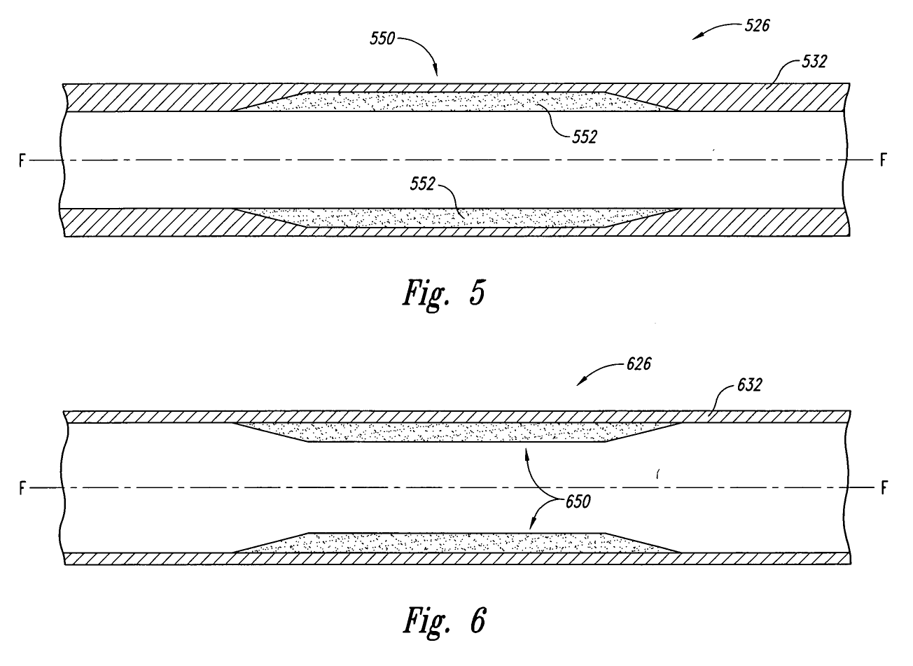

From the foregoing, it will be appreciated that specific embodiments of the invention have been described herein for purposes of illustration, but that various modifications may be made without deviating from the invention. For example, a hose assembly can include any number of surge suppression portions along the hose to reduce surge loads in the hose. Furthermore, in several embodiments the hose assembly and/or surge suppression portions may have other configurations. Referring to FIG. 5, for example, a hose 526 in accordance with another embodiment of the invention includes an outer layer 532 and a surge damping portion 550 including compressible material 552 disposed annularly about the hose 526 and at least partially within the outer layer 532. In one particular aspect of this embodiment, the hose 526 may not include an inner layer if the compressible material 552 of the surge damping portion 550 includes a material suitable for contact with fuel or other types of liquids. Referring to FIG. 6, a hose 626 in accordance with still another embodiment of the invention can include a surge damping portion 650 projecting inwardly from an outer layer 632 of the hose 626, rather than being in and/or between one or more layers of the hose 626. Aspects of the invention described in the context of particular embodiments may be combined or eliminated in other embodiments. For example, the surge damping features and methods described in the context of specific aircraft refueling systems can be implemented in a number of other aircraft or non-aircraft systems that include hose assemblies or fluid conduits where surge loads are an issue (e.g., petroleum industry applications, automotive applications, industrial or residential plumbing systems, etc.). Certain aspects of the invention are accordingly not limited to aircraft refueling systems. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited except as by the appended claims.

I/we claim:

1. An aerial refueling system, comprising:
a fuel delivery device that includes:
a flexible fuel line configured to be deployed overboard an aircraft during aerial refueling;
a drogue coupled to the fuel line; and
a surge damping portion positioned along the fuel line away from the aircraft to suppress surge loads traveling along the fuel line.

2. The system of claim 1 wherein the surge damping portion includes a compressible material disposed annularly about at least a portion of the fuel line.

3. The system of claim 2 wherein the compressible material includes at least one of a solid rubber, foam rubber, silicone rubber, closed-cell foam, and a foam material.

4. The system of claim 2 wherein the compressible material has a durometer value of 10 to 90.

5. The system of claim 2 wherein the fuel line includes:
an inner layer positioned to transmit the surge loads into the compressible material; and
an outer layer disposed annularly about at least a portion of the inner layer and the compressible material.

6. The system of claim 2 wherein:
the fuel line includes (a) an inner layer positioned to transmit the surge loads into the surge damping portion, and (b) an outer layer disposed annularly about at least a portion of the inner layer and the surge damping portion; and
the compressible material includes one or more bladders between the inner layer and the outer layer and positioned to be at least partially filled with a gas.

7. The system of claim 6 wherein the one or more bladders between the inner layer and outer layer are positioned to be at least partially filled with air.

8. The system of claim 1 wherein the fuel delivery device includes a plurality of surge damping portions along the fuel line away from the aircraft.

9. The system of claim 1, further comprising the aircraft, wherein the aircraft includes a tanker aircraft, and wherein the fuel delivery device is carried by the tanker aircraft.

10. The system of claim 1 wherein the fuel line includes:
a first portion configured to remain aboard the aircraft; and
a second portion configured to be deployed overboard the aircraft, and wherein the surge damping portion is in the second portion of the fuel line.

11. The system of claim 1 further comprising the aircraft, wherein the aircraft includes a tanker aircraft, and wherein:
the fuel delivery device is carried by the tanker aircraft and includes a deployable portion configured to be deployed overboard the tanker aircraft during aerial refueling, the deployable portion including:
at least a portion of the fuel line, the fuel line including (a) an inner layer positioned to transmit the surge loads into the surge damping portion, and (b) an outer layer disposed annularly about at least a portion of the inner layer and the surge damping portion;
the drogue; and
the surge damping portion positioned along the fuel line, the surge damping portion including a compressible material disposed annularly about at least a portion of the fuel line between the inner layer of the fuel line and the outer layer of the fuel line to dampen radially expanding surge loads traveling along a flow axis of the fuel line.

12. A system for reducing surge loads in hose assemblies, the system comprising:
a hose configured to carry a fluid, the hose including a first segment and a second segment; and
a surge damping portion positioned annularly about at least a portion of the second segment of the hose, the surge damping portion being positioned to dampen radially expanding surge loads traveling along a longitudinal axis of the hose.

13. The system of claim 12 wherein the surge damping portion is integral with the second segment of the hose.

14. The system of claim 12 wherein the surge damping portion includes a compressible material disposed annularly about at least a portion of the second segment of the hose.

15. The system of claim 14 wherein the hose includes:
an inner layer positioned to transmit the surge loads into the compressible material; and
an outer layer disposed annularly about at least a portion of the inner layer and the compressible material.

16. The system of claim 14 wherein the compressible material includes at least one of a solid rubber, foam rubber, silicone rubber, closed-cell foam, and a foam material.

17. The system of claim 14 wherein the compressible material has a durometer value of 10 to 90.

18. The system of claim 14 wherein:
the hose includes (a) an inner layer positioned to transmit the surge loads into the compressible material, and (b) an outer layer disposed annularly about at least a portion of the inner layer and the compressible material; and
the compressible material includes one or more bladders between the inner layer and the outer layer and positioned to be at least partially filled with a gas.

19. The system of claim 12 wherein the hose includes a plurality of surge damping portions along the second segment of the hose.

20. A method for refueling an aircraft, comprising:
aerially deploying from a tanker aircraft a portion of a refueling system that includes a flexible fuel line and a drogue; and
suppressing surge loads traveling along the fuel line using a surge damping portion positioned along at least a portion of the fuel line away from the tanker aircraft.

21. The method of claim 20 wherein suppressing surge loads traveling along the fuel line using a surge damping portion includes transferring energy from radially expanding surge loads into a compressible material disposed radially about at least a portion of the fuel line.

22. The method of claim 21 wherein transferring energy from radially expanding surge loads into a compressible material includes transferring energy from the surge loads into a compressible material including at least one of a solid rubber, foam rubber, silicone rubber, closed-cell foam, and a foam material.

23. The method of claim 21 wherein transferring energy from radially expanding surge loads into a compressible material includes transferring energy from the surge loads into a compressible material including a bladder at least partially filled with a gas.

24. The method of claim 23, further comprising controlling the rate at which energy from the surge loads is transferred into the bladder by adjustably controlling the gas pressure in the bladder.

25. The method of claim 20 wherein suppressing surge loads traveling along the fuel line using a surge damping portion includes suppressing surge loads using a plurality of surge damping portions positioned along the fuel line away from the aircraft.
